(19) United States
(12) Patent Application Publication
(10) Pub. No.: US 2013/0236728 A1
(43) Pub. Date: Sep. 12, 2013

(54) LAMINATED BODY

(71) Applicants: Kazuho Uchida, Osaka (JP); Tsutomu Ando, Osaka (JP); Daisuke Nakajima, Kouka-city (JP)

(72) Inventors: Kazuho Uchida, Osaka (JP); Tsutomu Ando, Osaka (JP); Daisuke Nakajima, Kouka-city (JP)

(21) Appl. No.: 13/415,755

(22) Filed: Mar. 8, 2012

(51) Int. Cl. B32B 27/08; B32B 27/28

(52) U.S. Cl. 428/412; 428/447

(57) ABSTRACT

A laminated body with surface layers having excellent abrasion resistance is disclosed. The laminated body is provided with a resin base material; a first layer laminated over at least part of the resin base material; and a second layer laminated on the second surface of the first layer opposite the first surface on which the resin base material is laminated. The first layer is formed by curing a first composition that contains: an inorganic polymer obtainable by hydrolytic condensation of inorganic polymer components including a silane compound represented by the following formula (1);

Si(R1)ₚ(OR2)₄₋ₚ (1)

a water-soluble polyfunctional (meth)acrylate; and an active energy ray polymerization initiator, and the second layer is formed by curing a second composition containing a thermosetting organosiloxane. In the formula (1), R1 represents a C₁₋₃₀ organic group containing a polymerizable double bond; R2 represents a C₁₋₆ alkyl group; and p is 1 or 2.

### TECHNICAL FIELD

The present invention relates to a laminated body that is provided with surface layers having excellent abrasion resistance on the surface of a resin base material.

### BACKGROUND ART

Poly(meth)acrylate resins and polycarbonate resins are excellent in moldability and processability. Resin molded products made of a poly(meth)acrylate resin or a polycarbonate resin are widely used for applications such as glasses, contact lens, and lens for optical devices since these resin molded products are lighter than glass. In particular, resin molded products made of a polycarbonate resin are suitably used in the form of a large-size resin molded product since these resin molded products are excellent in impact resistance. For example, resin molded products made of a polycarbonate resin are in practical use as head lamp lens for vehicles, and window materials for trains, bullet trains and the like.

These resin molded products, however, have lower surface hardness than those of glass. Therefore, these resin molded products tend to be damaged during transportation or attachment of components, or in use. In addition, the durability of these resin molded products is low.

Conventionally, in order to enhance the hardness, a surface layer with higher hardness has been formed on the surface of these resin molded products.

For example, Patent Document 1 discloses a resin molded product provided with a surface layer formed from a composition that contains a polyfunctional acrylate monomer, colloidal silica, an acryloxy functional silane, and a photopolymerization initiator. In Examples of Patent Document 1, 3-methacryloxypropyltrimethoxysilane is used as the acryloxy functional silane.

Patent Document 2 discloses a resin molded product provided with a surface layer formed from a composition that contains an ultraviolet curing resin and a surface modifier containing a siloxane compound. Patent Document 2 specifically teaches, as examples of the ultraviolet curing resin, acrylic oligomers containing at least two acryloyl groups in the molecule, and acrylic monomers or oligomers with colloidal silica linked thereto, and specifically teaches, as examples of the siloxane compound, polyether-modified dimethylpolysiloxane copolymers, polyether-modified methyl alkyl polysiloxane copolymers, and polyester-modified dimethylpolysiloxane.

Patent Document 3 discloses a resin molded product provided with two surface layers which are formed by forming a primer layer using a thermoplastic acrylic polymer, and then forming a top coat layer over the surface of the primer layer using a colloidal silica filled organopolysiloxane.

Patent Document 4 discloses a resin molded product provided with two surface layers which are formed by forming a primer layer by irradiating a photocurable polysiloxane composition with light, and then forming a top coat layer over the surface of the primer layer by heating a silicone thermally polymerizable curing composition.
Patent Document 1: JP 57-131214 A
Patent Document 2: JP 2003-338089 A
Patent Document 3: JP 04-002614 B
Patent Document 4: JP 07-118425 A

### SUMMARY OF THE INVENTION

### Problems to be Solved by the Invention

The surface layers of Patent Documents 1 to 4 may not have sufficient hardness.

Regarding Patent Document 3, the adhesion between the primer layer and the top coat layer may be low. Regarding Patent Document 4, the interface between the primer layer and the top coat layer may not be uniform, which may lead to poor external appearance of the surface layers.

An object of the present invention is to provide a laminated body provided with surface layers having excellent abrasion resistance.

### Means for Solving the Problems

The present invention provides a laminated body that includes: a resin base material; a first layer laminated over at least part of the resin base material; and a second layer laminated on the other surface of the first layer opposite to the surface on which the resin base material is laminated. The first layer is formed by curing a first composition that contains: an inorganic polymer obtainable by hydrolytic condensation of inorganic polymer components including a silane compound represented by the formula (1); a water-soluble polyfunctional (meth)acrylate; and an active energy ray polymerization initiator, and the second layer is formed by curing a second composition that contains a thermosetting organosiloxane.

Si(R1)ₚ(OR2)₄₋ₚ (1)

In the formula (1), R1 represents a C₁₋₃₀ organic group containing a polymerizable double bond; R2 represents a C₁₋₆ alkyl group; and p is 1 or 2. When p is 2, the R1s may be the same as or different from one another. The R2s may be the same as or different from one another.

Ina specific aspect of the laminated body according to the present invention, the water-soluble polyfunctional (meth)acrylate in the first composition is an oxyalkylene-modified glycerin (meth)acrylate represented by the formula (2) or an alkylene glycol di(meth)acrylate represented by the formula (3).

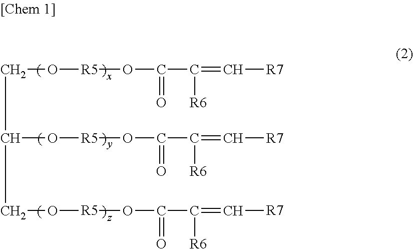

In the formula (2), R5 represents an ethylene group or a propylene group; R6 represents a hydrogen or a methyl group; R7 represents a hydrogen or a methyl group; and the sum of x, y and z is an integer of 6 to 30. The R5s, the R6s and the R7s may be the same as or different from one another.

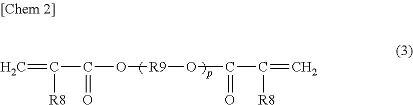

In the formula (3), R8 represents a hydrogen or a methyl group; R9 represents an ethylene group or a propylene group; and p is an integer of 1 to 25.

In another specific aspect of the laminated body according to the present invention, the thermosetting organosiloxane in the second composition is a hydrolysis condensation product of components including a silane compound represented by the formula (4).

Si(R11)ₘ(OR12)₄₋ₘ (4)

In the formula (4), R11 represents a phenyl group, a C₁₋₃₀ alkyl group, or a C₁₋₃₀ hydrocarbon group containing an epoxy group; R12 represents a C₁₋₆ alkyl group; and m is an integer of 0 to 2. When m is 2, the R11s may be the same as or different from one another. The R12s may be the same as or different from one another.

In still another specific aspect of the laminated body according to the present invention, the resin base material is a polycarbonate resin base material.

### Effects of the Invention

In the present invention, first and second layers are formed on the surface of a resin base material as surface layers; the first layer is formed by curing a first composition that contains an inorganic polymer obtainable by hydrolytic condensation of inorganic polymer components including a silane compound represented by the following formula (1), a water-soluble polyfunctional (meth)acrylate, and an active energy ray polymerization initiator; and the second layer is formed by curing a second composition that contains a thermosetting organosiloxane. Accordingly, it is possible to enhance the abrasion resistance of the surface layers.

### BRIEF DESCRIPTION OF THE DRAWINGS

FIGS. 1 (a) and 1(b) are a perspective view and a front cross-sectional view illustrating a laminated body of one embodiment of the present invention.

FIGS. 2 (a) to 2(c) are front cross-sectional views illustrating processes for forming a laminated body of one embodiment of the present invention.

### MODES FOR CARRYING OUT THE INVENTION

The following description specifically explains embodiments of the present invention referring to the drawings. These embodiments are provided for understanding of the present invention.

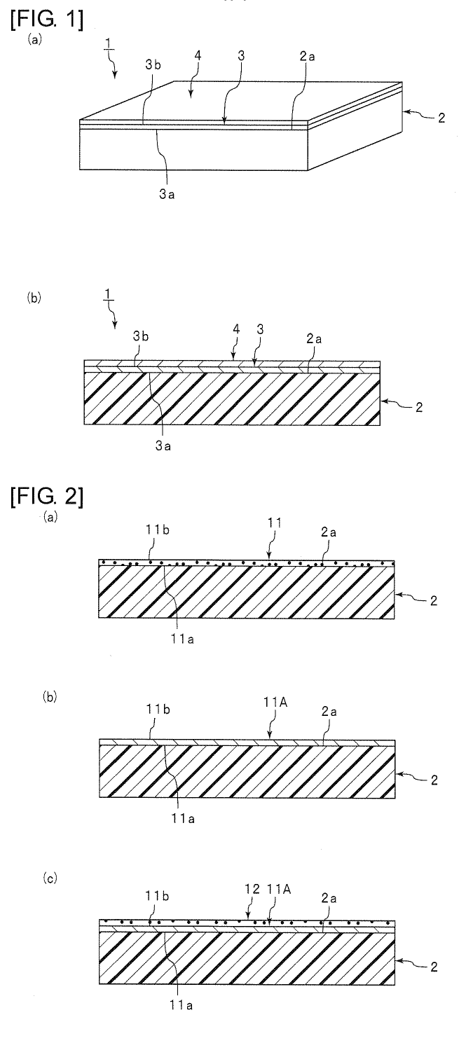

FIGS. 1 (a) and 1(b) are a perspective view and a front cross-sectional view illustrating a laminated body of one embodiment of the present invention.

As shown in FIGS. 1(a) and 1(b), a laminated body 1 includes a resin base material 2; a first layer 3 that is laminated on the surface 2a of the resin base material 2, and the second layer 4 that is laminated on the second surface 3b of the first layer 3 opposite to the first surface 3a on which the resin base material 2 is laminated. Thus, the laminated body 1 is provided with the first and second layers 3 and 4 as surface layers.

The first layer 3 is laminated over the entire area of a main surface of the resin base material 2. However, the first layer 3 may be formed over at least part of the resin material 2, and namely may not be necessarily formed over the entire area of the surface of the resin base material 2. For example, the first and second layers 3 and 4 may be laminated, as surface layers, over only an area of the surface 2a of the resin base material 2 which is required to be abrasion resistant. Alternatively, the first and second layers 3 and 4 may be formed over both main surfaces of the resin base material 2.

The resin base material 2 is formed from a resin. The resin for the resin base material 2 is not particularly limited. Examples of the resin for the resin base material 2 include poly(meth)acrylate resins, polycarbonate resins, polyethylene terephthalate, polybutylene terephthalate, styrene resins (e.g. ABS), vinyl chloride resins, and cellulose acetate. In particular, poly(meth)acrylate resin or polycarbonate resin is preferred and polycarbonate resin is more preferred. Poly(meth)acrylate resins and polycarbonate resins are excellent in terms of moldability and processability. In addition, resin base materials formed from poly (meth)acrylate resins and polycarbonate resins are lighter than those of glass, and resin base materials formed from polycarbonate resins has good impact resistance. Therefore, the resin base material 2 is preferably a poly(meth)acrylate resin base material or a polycarbonate resin base material, and is more preferably a polycarbonate resin base material.

The shape of the resin base material 2 is not particularly limited and may be a plate shape or film shape.

Since the first layer 3 is formed to enhance the adhesion between the resin base material 2 and the second layer 4, the thickness of the first layer 3 can be appropriately determined in such a manner to enhance the adhesion. The preferable lower limit of the thickness of the first layer 3 is 1 μm, and the preferable upper limit thereof is 20 μm. In view of sufficiently enhancing the abrasion resistance, the preferable lower limit of the thickness of the second layer 4 is 0.1 μm and the preferable upper limit thereof is 20 μm.

For example, the laminated body 1 can be formed as follows.

As shown in FIG. 2 (a), a first composition layer 11 is formed by applying the first composition to the surface 2a of the resin base material 2.

Then, as shown in FIG. 2(b), the first composition layer 11 is cured by irradiating the first composition layer 11 with an active energy ray. As a result of the active energy ray radiation, a photocured first composition layer 11A is formed.

When the first composition layer 11 is irradiated with an active energy ray, for example, an active energy ray polymerization initiator is decomposed to generate radicals, which in turn cause a first polymerization of a water-soluble polyfunctional (meth)acrylate and a polymerizable double bond of an inorganic polymer derived from a silane compound represented by the formula (1), resulting in formation of crosslinks.

Examples of the active energy ray emitted to cure the first composition layer 11 include ultraviolet rays, electron beams, α-rays, β-rays, γ-rays, X-rays, infrared rays, and visible light rays. Among these active energy rays, ultraviolet rays and electron beams are preferable because they provide excellent curability and resulting cured products are less likely to degrade.

To cure the first composition layer 11 by ultraviolet radiation, various ultraviolet radiation devices can be used. Examples of usable light sources include xenon lamps, high-pressure mercury lamps, and metal halide lamps. The ultraviolet radiation energy is preferably in the range of 10 to 10,000 mJ/cm² and is more preferably in the range of 100 to 5,000 mJ/cm². When the ultraviolet radiation energy is too low, the first composition layer 11 is less likely to be cured, which tends to result in low abrasion resistance of the first layer 3 and the surface layers including the first layer 3, and poor adhesion. When the ultraviolet radiation energy is too high, the first layer 3 and the surface layers including the first layer 3 may be degraded or may be less transparent.

To cure the first composition layer 11 by electron beam radiation, various electron beam radiation devices can be used. The electron beam radiation energy is preferably in the range of 0.5 to 20 Mrad and is more preferably in the range of 1.0 to 10 Mrad. When the electron beam radiation energy is too low, the first composition layer 11 is less likely to be cured, which tends to result in low abrasion resistance of the first layer 3 and the surface layers including the first layer 3. When the electron beam radiation energy is too high, the first layer 3 and the surface layers including the first layer 3 may be degraded or may be less transparent.

Next, as shown in FIG. 2 (c), a second composition layer 12 is formed by applying a second composition to the second surface 11b of the photocured first composition layer 11A, which is opposite to the first surface 11a on which the resin base material 2 is laminated.

When the second composition layer 12 is formed, the first composition layer 11A needs to be photocured to such an extent that no disruption occurs between the photocured first composition layer 11A and the second composition layer 12. If a sufficient amount of crosslinks are formed in the photocured first composition layer 11A, the resulting laminated body has surface layers having high abrasion resistance.

Next, the photocured first composition layer 11A and the second composition layer 12 are cured by firing the photocured first composition layer 11A and the second composition layer 12. The firing allows a second polymerization in which the photo-cross-linked inorganic polymer in the photocured first composition layer 11A is further condensed, to proceed. Consequently, the photocured first composition layer 11A is further cured so that the first layer 3 having a high hardness is formed. Further, as a result of the firing, the thermosetting organosiloxane in the second composition layer 12 is condensed so that the second composition layer 12 is cured. In this manner, the second layer 4 is formed.

In addition, during the firing, the photo-cross-linked inorganic polymer in the photocured first composition layer 11A is also condensed with the thermosetting organosiloxane in the second composition layer 12. Consequently, the adhesion between the first layer 3 and the second layer 4 is enhanced, resulting in enhanced abrasion resistance of the first and second layers 3 and 4 serving as surface layers.

The firing temperature in the firing of the photocured first composition layer 11A and the second composition layer 12 is not particularly limited. The firing temperature is preferably in the range of 110° C. to 130° C. The reaction period can be appropriately changed depending on the firing temperature and is not particularly limited. Preferably, the reaction period is in the range of 30 minutes to 4 hours.

Hereinafter, the first composition for forming the first layer 3 and the second composition for forming the second layer 4 are described in detail.

(First Composition)

The first composition for forming the first layer 3 contains an inorganic polymer obtainable by hydrolytic condensation of inorganic polymer components; a water-soluble polyfunctional (meth)acrylate; and an active energy ray polymerization initiator. The first composition is an active energy ray-curable composition.

The term “inorganic polymer components” used herein is intended to indicate components which are used for production of the inorganic polymer and each partially constitute the backbone of the produced inorganic polymer.

The inorganic polymer is an inorganic polymer obtainable by hydrolytic condensation of inorganic polymer components including a silane compound represented by the following formula (1).

Si(R1)ₚ(OR2)₄₋ₚ (1)

In the formula (1), R1 represents a C₁₋₃₀ organic group containing a polymerizable double bond; R2 represents a C₁₋₆ alkyl group; and p is 1 or 2. When p is 2, the R1s may be the same as or different from one another. The R2s may be the same as or different from one another.

Examples of the polymerizable double bond in R1 in the formula (1) include carbon-carbon double bond.

Specific examples of R1 in the formula (1) include vinyl group, allyl group, isopropenyl group, and 3-(meth)acryloxyalkyl group. The term “(meth)acryloxy” used herein means methacryloxy or acryloxy.

Examples of the (meth) acryloxyalkyl groups include (meth)acryloxymethyl group, (meth)acryloxyethyl group, and (meth)acryloxypropyl group. In particular, R1 is preferably a (meth)acryloxyalkyl group. The minimum number of carbon atoms in R1 is preferably 2, and the maximum number of carbon atoms in R1 is preferably 30 and is more preferably 10.

Specific examples of R2 in the formula (1) include methyl group, ethyl group, n-propyl group, isopropyl group, n-butyl group, and isobutyl group.

Specific examples of the silane compound represented by the formula (1) include 3-(meth)acryloxypropyltrimethoxysilane, 3-(meth)acryloxypropyltriethoxysilane, and 3-(meth)acryloxypropylmethyldimethoxysilane. Any of these silane compounds represented by the formula (1) may be used alone, or two or more of these may be used in combination.

The inorganic polymer components may include compounds other than the compound represented by the formula (1). The other compounds may be copolymerized or graft polymerized with the compound represented by the formula (1), provided that they do not deteriorate the transparency and abrasion resistance of the first layer 3 and the surface layers including the first layer 3.

The inorganic polymer can be obtained by adding a solvent or water, and a catalyst and the like to the inorganic polymer components including the compound represented by the formula (1); hydrolytically condensing the inorganic polymer components by a sol-gel method; and removing, from the reaction solution, the solvent, water, and alcohols and the like which have been generated by the condensation.

The solvent is not particularly limited, provided that it is capable of dissolving the compound represented the formula (1). Specific examples of the solvent include alcoholic solvents such as methanol, ethanol, n-propanol, and isopropanol; ether solvents such as tetrahydrofuran, 1,4-dioxane, 1,3-dioxane, and diethylether; hydrocarbon solvents such as benzene, toluene, and n-hexane; keton solvents such as acetone, methyl ethyl ketone, and cyclohexanone; and ester solvents such as ethyl acetate and butyl acetate. Any of these solvents may be used alone, or two or more of these may be used in combination. In particular, low-boiling-point solvents are preferable because they can be easily volatilized. Preferred examples of the low-boiling-point solvents include alcoholic solvents such as methanol, ethanol, n-propanol, and isopropanol.

Water is used in the hydrolysis reaction to convert the alkoxy groups of the compound represented by the formula (1) into hydroxyl groups. The amount of water used in the hydrolysis reaction is preferably 0.1 to 10 molar equivalents of the alkoxy groups. When the amount of water used in the hydrolysis reaction is too little, the hydrolysis reaction and the condensation reaction do not sufficiently proceed and thereby the inorganic polymer may not be produced. When the amount of water used in the hydrolysis reaction is too much, the inorganic polymer may turn into a gel. Therefore, the reaction time and the reaction temperature should be optimally controlled.

Specific examples of the catalyst include inorganic acids such as hydrochloric acid, sulfuric acid, nitric acid, phosphoric acid, nitrous acid, perchloric acid, and sulfamic acid; and organic acids such as formic acid, acetic acid, propionic acid, butyric acid, oxalic acid, succinic acid, maleic acid, lactic acid, p-toluenesulfonic acid, and acrylic acid. In particular, the catalyst is more preferably hydrochloric acid, acetic acid, or acrylic acid because they facilitate control of the hydrolysis reaction and the condensation reaction.

The water-soluble polyfunctional (meth)acrylate in the first composition is not particularly limited, provided that it is water-soluble and has two or more (meth)acryloyl groups. Only one water-soluble polyfunctional (meth)acrylate may be used alone, or two or more water-soluble polyfunctional (meth)acrylates may be used in combination. The term “(meth)acryloyl” used herein means acryloyl or methacryloyl. The term “(meth)acrylate” used herein means acrylate or methacrylate.

Specific examples of the water-soluble polyfunctional (meth)acrylate include triethylene glycol di(meth)acrylate and pentaerythritol tri(meth)acrylate.

Examples of the water-soluble polyfunctional (meth)acrylate include oxyalkylene-modified glycerin (meth)acrylates represented by the following formula (2) and alkylene glycol di (meth)acrylates represented by the following formula (3). The water-soluble polyfunctional (meth)acrylate is preferably an oxyalkylene-modified glycerin (meth)acrylate represented by the formula (2) or an alkylene glycol di(meth)acrylate represented by the formula (3). The use of these preferable water-soluble polyfunctional (meth) acrylates further enhances the abrasion resistance of the first layer 3 and the surface layers including the first layer 3.

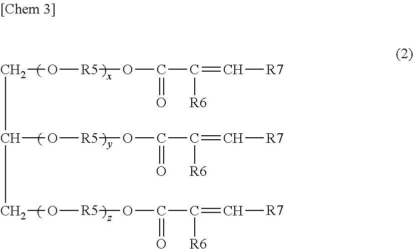

In the formula (2), R5 represents an ethylene group or a propylene group; R6 represents a hydrogen or a methyl group; R7 represents a hydrogen or a methyl group; and the sum of x, y and z is an integer of 6 to 30. The R5s, the R6s and the R7s may be the same as or different from one another.

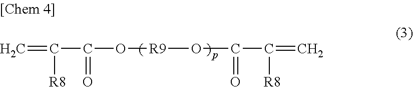

In the formula (3), R8 represents a hydrogen or a methyl group; R9 represents an ethylene group or a propylene group; and p is an integer of 1 to 25.

The water-soluble polyfunctional (meth)acrylate preferably contains at least three alkylene glycol units, more preferably contains at least six alkylene glycol units, and furthermore preferably contains at least nine alkylene glycol units. A larger number of alkylene glycol units leads to higher abrasion resistance of the first layer 3 and the surface layers including the first layer 3.

The weight ratio between the inorganic polymer and the water-soluble polyfunctional (meth)acrylate in the first composition is not particularly limited. When the amount of the water-soluble polyfunctional (meth)acrylate is too much, the adhesion between the first layer 3 and the second layer 4 may be low, which tends to result in low abrasion resistance. Accordingly, the weight ratio between the inorganic polymer and the water-soluble polyfunctional (meth)acrylate (inorganic polymer:water-soluble polyfunctional (meth)acrylate) in the first composition is preferably 5:95 to 90:10, and more preferably 10:90 to 60:40.

The water-soluble polyfunctional (meth)acrylate may be added after polymerizing the inorganic polymer components through the hydrolysis and condensation reactions by a sol-gel method and removing the solvent, water and the like. Alternatively, the water-soluble polyfunctional (meth)acrylate may be added immediately after polymerizing the inorganic polymer components.

The active energy ray polymerization initiator in the first composition is not particularly limited. The active energy ray polymerization initiator is preferably a photopolymerization initiator that produces radicals in response to active energy ray radiation. Examples of the photopolymerization initiator include common commercial photopolymerization initiators.

Examples of the photopolymerization initiator include benzoin compounds, acetophenone compounds, anthraquinone compounds, thioxanthone compounds, ketal compounds, benzophenone compounds, and phosphine oxide compounds. Any of these photopolymerization initiators may be used alone, or two or more of these may be used in combination.

Examples of the benzoin compounds include benzoin, benzoin methyl ether, benzoin ethyl ether, benzoin propyl ether, and benzoin isobutyl ether.

Examples of the acetophenone compounds include acetophenone, 2,2-diethoxy-2-phenylacetophenone, 2,2-dimethoxy-1,2-diphenylethane-1-one, 1,1-dichloroacetophenone, 2-hydroxy-2-methyl-phenylpropane-1-one, diethoxyacetophenone, 1-hydroxycyclohexyl phenyl ketone, and 2-methyl-1-[4-(methylthio)phenyl]-2-morpholinopropane-1-one

Examples of the anthraquinone compounds include 2-ethylanthraquinone, 2-t-butylanthraquinone, 2-chloroanthraquinone, and 2-amylanthraquinone.

Examples of the thioxanthone compounds include 2,4-diethylthioxanthone, 2-isopropylthioxanthone, and 2-chlorothioxanthone.

Examples of the ketal compounds include acetophenone dimethyl ketal and benzyl dimethyl ketal.

Examples of the benzophenone compounds include benzophenone, 4-benzoyl-4′-methyldiphenylsulfide, and 4,4′-bismethylaminobenzophenone.

Examples of the phosphine oxides include 2,4,6-trimethylbenzoyldiphenylphosphine oxide, bis-(2,6-dimethoxybenzoyl)-2,4,4-trimethylpentylphosphine oxide, and bis(2,4,6-trimethylbenzoyl)-phenylphosphine oxide.

In view of preventing yellowing after light radiation, the photopolymerization initiator is preferably an acetophenone compound or a phosphine oxide compound. In view of further preventing yellowing after light radiation, the photopolymerization initiator is preferably 2,2-dimethoxy-1,2-diphenylethane-1-one, 1-hydroxycyclohexyl phenyl ketone, 2-methyl-1-[4-(methylthio) phenyl]-2-morpholino-propane-1-one, 2,4,6-trimethylbenzoyldiphenylphosphine oxide, or bis-(2,6-dimethoxybenzoyl)-2,4,4-trimethylpentylphosphine oxide, and is more preferably 2,2-dimethoxy-1,2-diphenylethane-1-one or 1-hydroxycyclohexyl phenyl ketone.

The amount of the active energy ray polymerization initiator can be appropriately determined depending on the type and the number of moles of polymerizable double bonds of the components in the first composition, and the active energy ray radiation energy (e.g. ultraviolet radiation energy). The amount of the active energy ray polymerization initiator is preferably in the range of 0.5 to 20% by weight in 100% by weight of the total of the inorganic polymer, the water-soluble polyfunctional (meth) acrylate, and the active energy ray polymerization initiator. The lower limit of the amount of the active energy ray polymerization initiator is preferably 2% by weight, and the upper limit thereof is preferably 15% by weight. When the amount of the active energy ray polymerization initiator is too little, the polymerization reaction may not sufficiently proceed, which tends to result in low abrasion resistance of the first layer 3 and the surface layers including the first layer 3. When the amount of the active energy ray polymerization initiator is too much, the first layer 3 and the surface layers including the first layer 3 may develop cracks or cause exudation of decomposed substances to the surface during the active energy ray radiation (e.g. ultraviolet radiation) or while the laminated body 1 is exposed to ultraviolet light or the like in use. Thus, the external appearance may become poor.

The first composition can be prepared by mixing the inorganic polymer, the water-soluble polyfunctional (meth)acrylate, the active energy ray polymerization initiator, and optionally other components.

(Second Composition)

The second composition for forming the second layer 4 contains a thermosetting organosiloxane.

In view of thermally curing the second composition sufficiently, the amount of the thermosetting organosiloxane is preferably in the range of 40 to 100% by weight in 100% by weight of the second composition. The lower limit of the amount of the thermosetting organosiloxane is more preferably 50% by weight. The amount of the thermosetting organosiloxane is particularly preferably 100% by weight in 100% by weight of the second composition.

The thermosetting organosiloxane is preferably a hydrolysis condensation product of components including a silane compound represented by the formula (4). The use of the hydrolysis condensation product results in much higher adhesion between the first layer 3 and the second layer 4, resulting in much higher abrasion resistance of the second layer 4 and the surface layers including the second layer 4.

Si(R11)ₘ(OR12)₄₋ₘ (4)

In the formula (4), R11 represents a phenyl group, a C₁₋₃₀ alkyl group, or a C₁₋₃₀ hydrocarbon group containing an epoxy group; R12 represents a C₁₋₆ alkyl group; and m is an integer of 0 to 2. When m is 2, the R11s may be the same as or different from one another. The R12s may be the same as or different from one another.

The hydrocarbon in the “C₁₋₃₀ hydrocarbon group having an epoxy group” herein is a group that contains an oxygen atom derived from the epoxy group in addition to carbon atoms and hydrogen atoms.

(Other Components Optionally Added in First and Second Compositions)

The first and second compositions may be diluted with a solvent so as to be uniformly applied to the resin base material.

Examples of the solvent include organic solvents. Any of the solvents may be used alone, or two or more of them may be used in combination. Specific examples of the organic solvents include alcoholic solvents such as ethanol, 1-propanol, 2-propanol, 1-butanol, t-butanol, and 1-methoxy-2-ethanol; ester solvents such as ethyl acetate, propyl acetate, and butyl acetate; ketone solvents such as methyl ethyl ketone, ethyl butyl ketone, methyl isobutyl ketone, and cyclohexanone; aromatic hydrocarbon solvents such as toluene and xylene; and petroleum solvents such as petroleum ether and petroleum naphtha.

The first and second compositions may optionally contain a leveling agent, a thixotropy imparting agent, a dispersant, a fire retardant, a colorant, an ultraviolet absorbent, an antioxidant, or the like.

The following description specifically explains the present invention by way of Examples and Comparative Examples. The present invention is not limited only to Examples described below.

The following first composition 1 to 8 and second composition A and B were prepared.

(First Composition 1)

Ethanol (95.2 g), 3-methacryloxypropyltrimethoxysilane (MPTS) (99.4 g (0.4 mol)), and methyltrimethoxysilane (MeTS) (109.0 g (0.8 mol)) were added to a flask and mixed into a mixed solution. Dilute hydrochloric acid prepared by diluting 12 N concentrated hydrochloric acid (8.75 g) with water (30.4 g) was dropwise added to the obtained mixed solution while the mixed solution was cooled to 0° C. The resulting mixture was stirred for 10 minutes and was stirred for another 10 minutes at room temperature. Thus, a mixed solution was prepared. The obtained mixed solution was heated to 80° C. and concentrated by an evaporator into a viscous and transparent inorganic polymer-containing solution (125.0 g).

To the obtained inorganic polymer-containing solution were added ethoxylated glyceryl triacrylate (500.0 g, NK ester A-GLY-9E, x+y+z=9, Shin-Nakamura Chemical Co., Ltd.), which corresponds to the water-soluble polyfunctional (meth)acrylate represented by the formula (2), 2,2-dimethoxy-1,2-diphenylethane-1-one (31.3 g, Irgacure 651, Ciba Specialty Chemicals) as a photopolymerization initiator, and isopropyl alcohol (625.0 g). In this manner, a first composition 1 was obtained.

(First Composition 2)

A viscous and transparent inorganic polymer-containing solution (111.5 g) was prepared in the same manner as that for the inorganic polymer-containing solution of the first composition 1, except that the amount of 3-methacryloxypropyltrimethoxysilane (MPTS) was changed from 99.4 g (0.4 mol) to 49.7 g (0.2 mol), and that the amount of methyltrimethoxysilane (MeTS) was changed from 109.0 g (0.8 mol) to 136.2 g (1.0 mol).

To the obtained inorganic polymer-containing solution were added ethoxylated glyceryl triacrylate (446.0 g, NK ester A-GLY-9E, Shin-Nakamura Chemical Co., Ltd.) as a water-soluble polyfunctional (meth)acrylate, 2,2-dimethoxy-1,2-diphenylethane-1-one (27.9 g, Irgacure 651, Ciba Specialty Chemicals) as a photopolymerization initiator, and isopropyl alcohol (557.5 g). In this manner, a first composition 2 was obtained.

(First Composition 3)

A viscous and transparent inorganic polymer-containing solution (208.7 g) was prepared in the same manner as that for the inorganic polymer-containing solution of the first composition 1, except that the amount of 3-methacryloxypropyltrimethoxysilane (MPTS) was changed from 99.4 g (0.4 mol) to 298.1 g (1.2 mol), and that methyltrimethoxysilane (MeTS) was not added.

To the obtained inorganic polymer-containing solution were added ethoxylated glyceryl triacrylate (834.8 g, NK ester A-GLY-9E, Shin-Nakamura Chemical Co., Ltd.) as a water-soluble polyfunctional (meth)acrylate, 2,2-dimethoxy-1,2-diphenylethane-1-one (52.2 g, Irgacure 651, Ciba Specialty Chemicals) as a photopolymerization initiator, and isopropyl alcohol (1043.5 g). In this manner, a first composition 3 was obtained.

(First Composition 4)

Ethanol (95.2 g), tetraethoxysilane (TEOS) (20.8 g (0.1 mol)), 3-methacryloxypropyltrimethoxysilane (MPTS) (74.5 g (0.3 mol)), and methyltrimethoxysilane (MeTS) (109.0 g (0.8 mol)) were added to a flask and mixed into a mixed solution. Dilute hydrochloric acid prepared by diluting 12 N concentrated hydrochloric acid (8.75 g) with water (30.4 g) was dropwise added to the obtained mixed solution while the mixed solution was cooled to 0° C. The resulting mixture was stirred for 10 minutes and was stirred for another 10 minutes at room temperature. Thus, a mixed solution was prepared. The obtained mixed solution was heated to 80° C. and concentrated by an evaporator into a viscous and transparent inorganic polymer-containing solution (122.6 g).

To the obtained inorganic polymer-containing solution were added ethoxylated glyceryl triacrylate (490.4 g, NK ester A-GLY-9E, Shin-Nakamura Chemical Co., Ltd.) as a water-soluble polyfunctional (meth)acrylate, 2,2-dimethoxy-1,2-diphenylethane-1-one (30.7 g, Irgacure 651, Ciba Specialty Chemicals) as a photopolymerization initiator, and isopropyl alcohol (613.0 g). In this manner, a first composition 4 was obtained.

(First Composition 5)

A first composition 5 was prepared in the same manner as that for the first composition 1, except that the amount of ethoxylated glyceryl triacrylate (NK ester A-GLY-9E, Shin-Nakamura Chemical Co., Ltd.) was changed to 250.0 g, the amount of 2,2-dimethoxy-1,2-diphenylethane-1-one (Irgacure 651, Ciba Specialty Chemicals) as a photopolymerization initiator was changed to 18.8 g, and the amount of isopropyl alcohol was changed to 375.0 g.

(First Composition 6)

A first composition 6 was prepared in the same manner as that for the first composition 1, except that the amount of ethoxylated glyceryl triacrylate (NK ester A-GLY-9E, Shin-Nakamura Chemical Co., Ltd.) was changed to 125.0 g, the amount of 2,2-dimethoxy-1,2-diphenylethane-1-one (Irgacure 651, Ciba Specialty Chemicals) as a photopolymerization initiator was changed to 12.5 g, and the amount of isopropyl alcohol was changed to 250.0 g.

(First Composition 7)

A first composition 7 was prepared in the same manner as that for the first composition 1, except that trimethylolpropane triacrylate (500.0 g, NK ester A-TMPT, Shin-Nakamura Chemical Co., Ltd.) was used as a non-water-soluble polyfunctional (meth)acrylate instead of ethoxylated glyceryl triacrylate (NK ester A-GLY-9E, Shin-Nakamura Chemical Co., Ltd.).

(First Composition 8)

A first composition 8 was prepared in the same manner as that for the first composition 1, except that ethoxylated glyceryl triacrylate (NK ester A-GLY-9E, Shin-Nakamura Chemical Co., Ltd.) was not added, the amount of 2,2-dimethoxy-1,2-diphenylethane-1-one (Irgacure 651, Ciba Specialty Chemicals) as a photopolymerization initiator was changed to 6.3 g, and the amount of isopropyl alcohol was changed to 125.0 g.

(Second Composition A)

Tetraethoxy silane (TEOS) (208 g, 1 mol), 0.01 N hydrochloric acid (81 g), and isopropyl alcohol (11 g) were added to a flask and mixed while the flask was cooled to 0° C. The mixture was stirred for 3 hours at 25° C. so that a hydrolysis condensation solution (300 g) of tetraethoxy silane was obtained.

Water (72 g) and acetic acid (20 g) were added to methyltrimethoxysilane (MeTS) (136.2 g, 1 mol), and the mixture was stirred for 1 hour at 25° C. In this manner, a hydrolysis condensation solution of methyltrimethoxysilane was obtained.

The obtained hydrolysis condensation solution of methyltrimethoxysilane was added to the hydrolysis condensation solution of tetraethoxy silane, and the mixture was stirred for 1 hour at 25° C. so that a solution was obtained. To the obtained solution was added isopropylalchol (272 g). In this manner, a second composition A (800 g) was obtained.

(Second Composition B)

A second composition B (800 g) was prepared in the same manner as that for the second composition A, except that phenyltrimethoxysilane (PhTS) (198.3 g, 1 mol) was used instead of methyltrimethoxysilane (MeTS)

The details of the obtained first compositions 1 to 8 and second compositions A and B are shown in Table 1 below. The amount of the diluent solvent in the second compositions A and B is not shown in Table 1.

TABLE 1

| | | | First Composition | | | | | | | | Second Composition | |
|---|---|---|---|---|---|---|---|---|---|---|---|---|
| | | | Compo- | Compo- | Compo- | Compo- | Compo- | Compo- | Compo- | Compo- | Compo- | Compo- |
| | | | sition 1 | sition 2 | sition 3 | sition 4 | sition 5 | sition 6 | sition 7 | sition 8 | sition A | sition B |
| Inorganic | MPTS | g | 99.4 | 49.7 | 298.1 | 74.5 | 99.4 | 99.4 | 99.4 | 99.4 | | |
| Polymer | MeTS | g | 109.0 | 136.2 | | 109.0 | 109.0 | 109.0 | 109.0 | 109.0 | 136.2 | |
| | PhTS | g | | | | | | | | | | 198.3 |
| | TEOS | g | | | | 20.8 | | | | | 208.3 | 208.3 |
| | Yield of Inorganic Polymer | g | 125.0 | 111.5 | 208.7 | 122.6 | 125.0 | 125.0 | 125.0 | 125.0 | | |
| | Molecular Weight of | | 5,500 | 6,400 | 2,500 | 6,700 | 5,500 | 5,500 | 5,500 | 5,500 | | |
| | Inorganic Polymer | | | | | | | | | | | |
| Polyfunctional | Ethoxylated glyceryl | g | 500.0 | 446.0 | 834.8 | 490.4 | 250.0 | 125.0 | | | | |
| acrylate | triacrylate | | | | | | | | | | | |
| | Trimethylolpropane | g | | | | | | | 500.0 | | | |
| | triacrylate | | | | | | | | | | | |
| Photo- | 2,2-Dimethoxy-1, | g | 31.3 | 27.9 | 52.2 | 30.7 | 18.8 | 12.5 | 31.3 | 6.3 | | |
| polymerization | 2-diphenylethane-1-one | | | | | | | | | | | |
| Initiator | | | | | | | | | | | | |
| Diluent Solvent | Isopropyl Alcohol | g | 625.0 | 557.5 | 1043.5 | 613.0 | 375.0 | 250.0 | 625.0 | 125.0 | | |

### Examples 1 to 7 and Comparative Examples 1 and 3

Commercial transparent, colorless polycarbonate boards (10 cm in length×10 cm in width×4 mm in thickness) were prepared. The first compositions shown in Table 2 below were uniformly applied to these polycarbonate boards with a spin coater so that first composition layers were formed. The first composition layers were dried at room temperature (25° C.) for 10 minutes, and then irradiated with ultraviolet light in a nitrogen atmosphere by a 120-W high-pressure mercury lamp at a radiation energy of 1,500 mJ/cm².

Next, the second compositions shown in Table 2 were uniformly applied to the photocured first composition layers with a spin coater so that second composition layers were formed. The second composition layers were dried for 10 minutes at room temperature (25° C.). Subsequently, the second composition layers were heated in an oven at 125° C. for 2 hours. In this manner, first and second layers were formed on the upper surface of each polycarbonate board, and thus laminates were obtained.

### Comparative Example 2

A commercial transparent, colorless polycarbonate board (10 cm in length×10 cm in width×4 mm in thickness) was prepared. The second composition shown in Table 2 was uniformly applied to the polycarbonate board with a spin coater so that a second composition layer was formed. The second composition layer was dried for 10 minutes at room temperature (25° C.). Subsequently, the second composition layer was heated in an oven at 125° C. for 2 hours. In this manner, a second layer was formed on the upper surface of the polycarbonate board as a surface layer, and thus a laminate was obtained.

(1) Thickness of First Layer and Second Layer

Thin pieces of the laminates were prepared using an ultramicrotome. The cross-section of each thin piece was observed to evaluate the thickness of the first and second layers using a transmission electron microscope.

(2) External Appearance

The condition of the surface layers after the firing was visually observed and evaluated based on the following evaluation criteria.

### [External Appearance Evaluation Criteria]

∘: The surface layers were colorless and uniform.

Δ: The surface layers had some uneven portions, and a fluoroscopic image was distorted or the coat was cloudy.

x: The surface layers had cracks.

(3) Evaluation of Transparency

The haze value of the polycarbonate boards provided with surface layers formed thereon was measured with a haze meter (“TC-HIIIDPK”, Tokyo Denshoku Co., Ltd.) in accordance with JIS K7136. A smaller haze value corresponds to higher transparency.

Measurement of the haze value of the polycarbonate board without surface layers formed thereon resulted in 0.2%.

(4) Evaluation of Abrasion Resistance

Abrasion resistance was evaluated in accordance with JIS R3212 using a taber abrasion tester “rotary abrasion tester TS” (Toyo Seiki Seisaku-sho, LTD.) provided with a horizontal rotating table that rotates at a speed of 70 revolutions/min and a pair of abrasion wheels that are fixed at an interval of 65±3 mm and smoothly rotate. The abrasion wheels were CS-10F (Type IV). The haze difference (Δhaze %) between the haze after 500 cycles of a test under a load of 500 g and the initial haze was determined.

Measurement of the haze difference (Δhaze %) of the polycarbonate board without surface layers formed thereon resulted in 48%. The surface layer of the laminate of Comparative Example 2 had cracks and therefore was not evaluated for the abrasion resistance.

(5) Adhesiveness

On the surface layers formed on the surface of each polycarbonate board, 11 lengthwise cut lines and 11 widthwise cut lines were formed with a razor edge at intervals of 1 mm in accordance with JIS K5400 such that separated 100 grids in total were formed. A commercial cellophane adhesive tape was stuck to the surface layers with the grids and then the cellophane adhesive tape was rapidly removed from the surface layers in the 90° direction. Among the 100 grids in total, the number of grids in which the surface layers were not peeled off from the polycarbonate board and remained was counted.

Table 2 shows the results.

TABLE 2

| | | | | | | | | | Comp. | Comp. | Comp. |
|---|---|---|---|---|---|---|---|---|---|---|---|
| | | Ex. 1 | Ex. 2 | Ex. 3 | Ex. 4 | Ex. 5 | Ex. 6 | Ex. 7 | Ex. 1 | Ex. 2 | Ex. 3 |
| First Layer | Type of first composition | Compo- | Compo- | Compo- | Compo- | Compo- | Compo- | Compo- | Compo- | — | Compo- |
| | | sition 1 | sition 2 | sition 3 | sition 4 | sition 5 | sition 6 | sition 1 | sition 7 | | sition 8 |
| | Thickness (μm) | 7 | 7 | 7 | 7 | 7 | 7 | 7 | 7 | — | 7 |
| Second Layer | Type of second compostion | Compo- | Compo- | Compo- | Compo- | Compo- | Compo- | Compo- | Compo- | Compo- | Compo- |
| | | sition A | sition A | sition A | sition A | sition A | sition A | sition B | sition A | sition A | sition A |
| | Thickness (μm) | 5 | 5 | 5 | 5 | 5 | 5 | 5 | 5 | 5 | 5 |
| Evaluation | External Appearance | ∘ | ∘ | ∘ | ∘ | ∘ | ∘ | ∘ | Δ | x | ∘ |
| | | | | | | | | | (Cloudy) | | |
| | Transparency (haze value) (%) | 0.1 | 0.1 | 0.2 | 0.2 | 0.1 | 0.1 | 0.1 | 68.4 | 18.0 | 0.1 |
| | Abrasion Resistance (Δhaze) (%) | 3.0 | 3.2 | 2.5 | 3.0 | 3.4 | 4.5 | 3.5 | — | — | 64.2 |
| | Adhesiveness | 100 | 100 | 100 | 100 | 100 | 100 | 100 | — | — | 0 |

### EXPLANATION OF SYMBOLS

1 Laminate
2 Resin base material
2a Surface
3 First layer
3a First surface
3b Second surface
4 Second layer
11 First composition layer
11A Photocured first composition layer
11a First surface
11b Second surface
12 Second composition layer

1. A laminated body comprising:
a resin base material;
a first layer laminated over at least part of the resin base material; and
a second layer laminated on the other surface of the first layer opposite to the surface on which the resin base material is laminated,
wherein
the first layer is formed by curing a first composition that comprises: an inorganic polymer obtainable by hydrolytic condensation of inorganic polymer components including a silane compound; a water-soluble polyfunctional (meth)acrylate; and an active energy ray polymerization initiator,
the silane compound is represented by the following formula (1):
Si(R1)ₚ(OR2)₄₋ₚ (1)
wherein R1 represents a C₁₋₃₀ organic group containing a polymerizable double bond; R2 represents a C₁₋₆ alkyl group; p is 1 or 2; when p is 2, the R1s may be the same as or different from one another; and the R2s may be the same as or different from one another, and
the second layer is formed by curing a second composition that comprises a thermosetting organosiloxane.

2. The laminated body according to claim 1,
wherein
the water-soluble polyfunctional (meth)acrylate in the first composition is an oxyalkylene-modified glycerin (meth)acrylate represented by the formula (2) 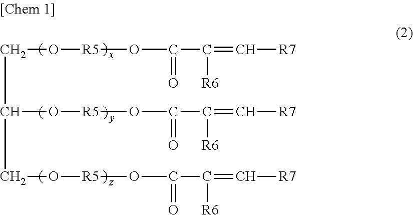
wherein R5 represents an ethylene group or a propylene group; R6 represents a hydrogen or a methyl group; R7 represents a hydrogen or a methyl group; the sum of x, y and z is an integer of 6 to 30; and the R5s, the R6s and the R7s may be same as or different from one another; or
an alkylene glycol di(meth)acrylate represented by the formula (3): 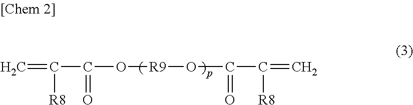
wherein R8 represents a hydrogen or a methyl group; R9 represents an ethylene group or a propylene group; and p is an integer of 1 to 25.

3. The laminated body according to claim 1,
wherein
the thermosetting organosiloxane in the second composition is a hydrolysis condensation product of components including a silane compound represented by the formula (4):
Si(R11)ₘ(OR12)₄₋ₘ (4)
wherein R11 represents a phenyl group, a C₁₋₃₀ alkyl group, or a C₁₋₃₀ hydrocarbon group containing an epoxy group; R12 represents a C₁₋₆ alkyl group; in is an integer of 0 to 2; when m is 2, the R11s may be the same as or different from one another; and the R12s may be the same as or different from one another.

4. The laminated body according to claim 2,
wherein
the thermosetting organosiloxane in the second composition is a hydrolysis condensation product of components including a silane compound represented by the formula (4):
Si(R11)ₘ(OR12)₄₋ₘ (4)
wherein R11 represents a phenyl group, a C₁₋₃₀ alkyl group, or a C₁₋₃₀ hydrocarbon group containing an epoxy group; R12 represents a C₁₋₆ alkyl group; m is an integer of 0 to 2; when m is 2, the R11s may be the same as or different from one another; and the R12s may be the same as or different from one another.

5. The laminated body according to claim 1,
wherein
the resin base material is a polycarbonate resin base material.

6. The laminated body according to claim 2,
wherein
the resin base material is a polycarbonate resin base material.

7. The laminated body according to claim 3,
wherein
the resin base material is a polycarbonate resin base material.

8. The laminated body according to claim 4,
wherein
the resin base material is a polycarbonate resin base material.
